(19) United States
(12) Patent Application Publication
(10) Pub. No.: US 2014/0172987 A1
(43) Pub. Date: Jun. 19, 2014

(54) COLLABORATIVE DOCUMENT PORTAL

(71) Applicant: Gia Duong Luu, Otterstadt (DE)

(72) Inventor: Gia Duong Luu, Otterstadt (DE)

(21) Appl. No.: 13/713,793

(22) Filed: Dec. 13, 2012

(51) Int. Cl. H04L 12/58

(52) U.S. Cl. CPC H04L 51/16
USPC 709/206

(57) ABSTRACT

A system and method for receiving a document from a first user that receives a message associated with the document from a second user, generates a communication thread for the document, the communication thread including the message from the second user, associates the communication thread with the document, provides the communication thread to the first user, receives a message from the first user, inserts the message from the first user in the communication thread, and provides the communication thread and a portion of the document to the second user for display.

### BACKGROUND

The present disclosure relates to electronic applications, and more particularly, to electronic applications that enable sharing one or more electronic files between two or more users. In addition, each of the users may associate one or more comments, or a communication thread, with an electronic file. The comments or thread can also be shared with other users.

Advances in computing technologies have enabled the sharing of electronic content between users. Some example methods of sharing electronic content include e-mail, share drives, flash drives, steamed content, facsimile, etc.

When business documents are shared between business partners, there is frequently a need for subsequent correspondence. For example, when an invoice is sent to a customer (by any means), the customer may not understand how the price was calculated, or why certain charges were applied. Typical methods for follow-up correspondence include return postal mail, facsimile, e-mail, or telephone call.

Unfortunately, there are several disadvantages of traditional communication channels. The string of back and forth results communications in a fragmented conversation over one or more mediums. An example communication string can result in several documents, e-mails, facsimiles, and telephone calls. Managing and tracking the correspondence can be challenging. Moreover, maintaining the context of each communication can be difficult and may often rely on an individual's memory.

Accordingly, the embodiments of the present disclosure are directed to systems and methods for electronic object collaboration.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 illustrates a method for sharing an electronic file between shared users through a collaboration application server according to an example embodiment of the present disclosure;

FIG. 2 illustrates a system level architecture that depicts the interaction between a remote electronic device and a backend collaboration system according to an example embodiment of the present disclosure;

FIG. 3 illustrates a representative view of a portable electronic device having a collaboration application according to an example embodiment of the present disclosure; and

FIG. 4 illustrates a representative architecture of a portable electronic device according to an example embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as telephone, text messenger, word processor, and collaboration applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, a collaboration application is used as an example embodiment, but it should be understood that the user interfaces and associated methods may be applied to other applications.

A collaboration application that enables users to share business documents is provided. For example, business partners may share business related documents with their business partners (e.g., customers, suppliers, distributors, contractors, etc.) by posting one or more business documents to a mutually accessible server (e.g., cloud based document storage server) as changeable or unchangeable versions. After logging-in to the server, a business partner may retrieve the document and initiate a conversation thread that can be associated with posted document. Referring back to an invoice example, a customer can post a question indicating that the price calculation is not understood. Upon receiving the customer's question, a business may supply an answer directly in the conversation thread. In addition, a new version of the invoice can also be provided.

The collaborative application can be a stand alone application or integrated with an enterprise software. In either case, users can be alerted about new postings from a business partner. The alert feature can use e-mail, text message, telephone, voicemail, etc.

In addition, a user may navigate between a plurality of documents posted by a business partner. The plurality of documents can be categorized and can also be placed in separate work areas corresponding to different types of documents and/or projects. For example, each of invoices, work orders, requests for information, proposals, etc. can each have separate work areas. Alternatively, a plurality of documents may be categorized by project. In this example, each document from the initial request for proposal (RFP) to the final invoice can be placed within a work area. In yet another alternative, a user can define a customized work area. For example, a user may prefer to view the last entry or the last ten entries within a communications thread.

In addition, a user may navigate the collaboration application using finger gestures on a touch screen interface to view various work areas and business documents. Alternatively, a user may also navigate the collaboration application using more conventional laptop or desktop computers having an Internet browser or standalone application. Irrespective of the interface, a user may view earlier or later segments of a communication thread by scrolling through the thread. In another example, a user can query the collaboration application for communications that occurred within a specified time range.

In some instances, detailed information may be displayed for a business document whereas aggregated, consolidated, or more general information can also be displayed. For example, an employee of a business partner may be able to view invoices, but the ability to initiate or view a communication thread relating to the invoice may be restricted to a supervisor.

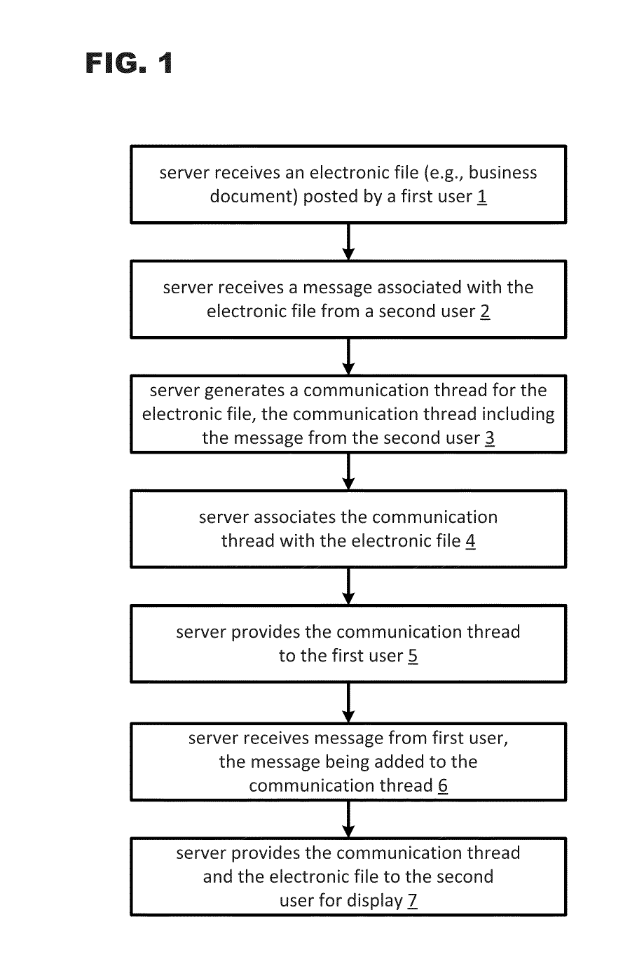

FIG. 1 illustrates a method for sharing an electronic file between shared users through a collaboration application server according to an example embodiment of the present disclosure.

At step 1, a remote or backend server, such as a collaboration application server, receives an electronic file, such as a business document, posted by a first user. The collaboration application enables business partners to share documents with their customers, suppliers, distributors, contactors, and other business partners by posting one or more business documents to a mutually accessible server or cloud. The electronic file may have any known or expected format (e.g., .doc, .pdf, .xls, .jpg, etc.).

Initially, the collaboration application may require that a user provide a login name and login password to access the collaboration application server. A user's credentials, stored within the server, may also be used to define a user's ability to access and/or comment on certain business documents. For example, an employee of a business partner may be able to view change orders, but the ability to initiate or view a communication thread relating to the change order may be restricted to a supervisor. In another example, certain types of business documents, such as progress reports, may be restricted to supervisors.

Upon receiving an electronic file, the server may send an alert to a second user indicating that the first user has posted an electronic file. Although the first and second users are typically members of different business organizations, a single organization can also use the collaboration application to share electronic files between its members. In either case, the mutually accessible server can generate and send an alert message to notify the first user that an electronic file has been posted. The alert feature can be relayed by one or more communication means including e-mail, text message, telephone, voicemail, etc. When alerts are sent by e-mail or text message, a link to the posted electronic file can be included.

The collaborative application may also include a preferences menu that enables a user to select one or more alert notification methods. The step of setting one or more alert notification methods may be performed initially when installing or first using the collaboration application. Afterwards, a user may change the alert notification methods, as desired.

At step 2, the server receives a message relating to the electronic file, the message being posted by the second user. Here, the second user can access the server to review the posted electronic file. When the content of the electronic file is clearly understood, further action may not be required from the second user. However, if the second user has a question, a message can be uploaded to the server, the message being intended for the first user. For example, a contractor may have a follow-up question about a work order. In another alternative, a first user may upload a message intended for the second user. For example, the first user may ask about the status of a previously posted work order.

Next, at step 3, the server generates a communication thread for the electronic file, the communication thread including the message posted by the second user. Once the communication thread is generated, the server then associates the communication thread with the posted electronic file, at step 4. For example, the electronic file and communication thread may be linked using a relational database.

Here, the server can send an alert to the first user indicating that the second user has posted a message. Again, the mutually accessible server can transmit one or more alert messages to notify the intended recipient, such as the first user, to indicate that a message has been posted in the communication thread. As discussed above, the alert message can be sent by a variety of electronic means. In addition, when alerts are sent by e-mail or text message, a link to the posted message or communication thread can be included.

At step 5, the first user can access the server to review the message posted by the second user, within the communication thread and associated with the electronic file. In turn, the server may receive a reply of the first user to second user's communication including a reply message within the communication thread and/or update to the electronic file, at step 6. Returning to the invoice example, if a customer correctly indicates that there is a problem with an invoice, a second invoice can be supplied in response to the communication thread. In instances when an alternate version of an electronic file is received, either the original or a new communication thread may be used for subsequent communications.

Once the first user replies to the second user's message, the server can generate an alert to the second user indicating that a reply has been received. Upon receipt of the alert message, the second user can view or retrieve, from the server, the last message within a communication thread. Lastly, at step 7, the mutually accessible server provides the communication thread and at least a portion of the electronic file to the second user, the second user's electronic device operable to simultaneously display the communication thread and electronic file.

Accordingly, a collaboration application that enables users to share business documents is provided. Business partners can employ the collaboration application to improve upon traditional communication methods that are already used with customers, suppliers, distributors, contactors, etc.

Depending on user preferences, the collaborative application can be a stand alone application or integrated with enterprise software. In addition, when a plurality of documents are exchanged between business partners, electronic folders, categories, and/or work areas can be use to organize the documents. Alternatively, the documents may be searched by name, date, poster, etc.

In some instances, detailed information may be displayed for a business document whereas aggregated, consolidated, or more general information can also be displayed. For example, an employee of a business partner may be able to view invoices, but the ability to initiate or view a communication thread relating to the invoice may be restricted to a supervisor.

The collaboration application may have search capabilities that enable a user to search for documents or communication threads. In some examples, a user may choose to search by content, date, business partner ID, document type, etc.

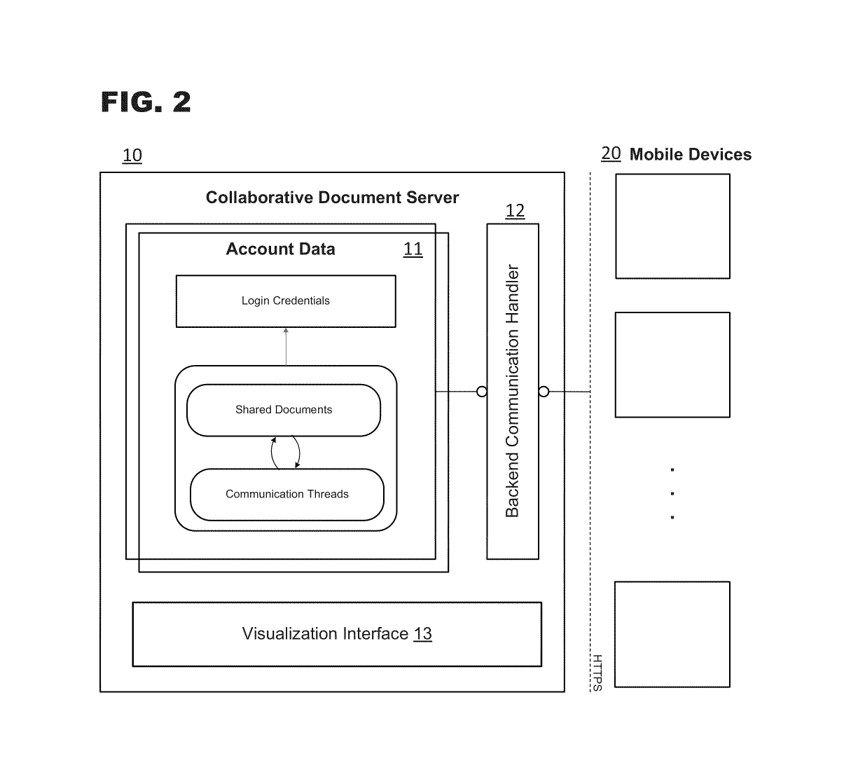

FIG. 2 illustrates a system level architecture that depicts the interaction between a remote electronic device and a backend collaboration system according to an example embodiment of the present disclosure.

As shown in FIG. 2, the system level architecture includes a collaborative document server 10 (e.g., a document management system) that is connected to one or remote electronic devices 20. The collaborative document server 10 can be connected to remote electronic devices 20 using known or expected network technologies, such as wireless local area networks (WLAN) or wireless wide area networks (WWAN), some examples of which include WiFi, long term evolution (LTE), and the like. Backend communication handler 12 manages communications functions for the collaborative document server 10. Similarly, each remote electronic device is also equipped with means for communication with a network, such as an antenna coupled to communication circuitry.

Collaborative document server 20 includes one or more account database 11 that stores several types of information that can be queried by the remote electronic devices 20. For example, account database 11 can store user login credentials, posted documents, and associated communication threads.

In addition, collaborative document server 10 may include a portal visualization interface 13 to generate one or more interfaces to be supplied to remote electronic devices 20. Alternatively, visualization features may be hosted on the remote electronic devices 20 whereas documents and communication threads would still be stored on collaborative document server 10. In either case, a visualization module manages the display functions of the collaboration application. As described above, such interfaces can enable a user to view a posted document and to initiate a communication thread.

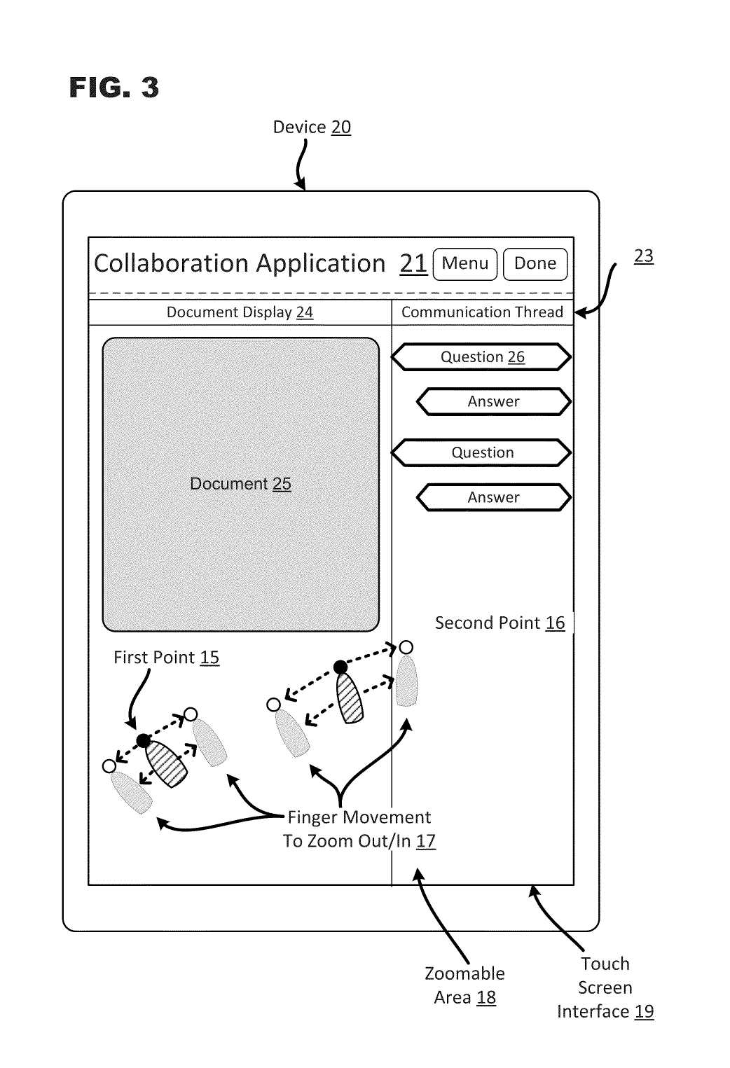

FIG. 3 illustrates a representative view of a portable electronic device having a collaboration application according to an example embodiment of the present disclosure. As shown in FIG. 3, a portable electronic device 20 includes a touch screen interface 19 and collaboration application 21 displayed thereon.

The collaboration application 21 may use a divided display to illustrate communication thread 23 associate with business document 25. The collaboration application 21 may include a zoomable area 18 which may encompass the whole display or parts of the display where the user may use their fingers 17 or other objects to zoom in or out of the display. The collaboration application 21 may also display entries 26 that are associated with the displayed document 25.

A user may zoom in or out of the divided display by initially selecting first and second points 15 and 16 on the display with their fingers or another object. The user may then drag one or more of their fingers to change the distance between the first point 15 and the second point 16. The change in the distance separating the two points may determine whether to zoom in or out of the document 25 or entries 26 and by what amount.

In some instances, whenever the zoom is readjusted, the entries and/or other content associated with the document 26 may also be reassessed for display. For example, the entries 26 may be resized according to the zoom level and/or a different number of entries displayed to make the entries more readable and/or selectable by a user.

Entries can include additional information, such as any information about the document, corresponding tasks, or events associated with a respective document. Information displayed on screen may also be consolidated if the user zooms out of the collaboration application 21.

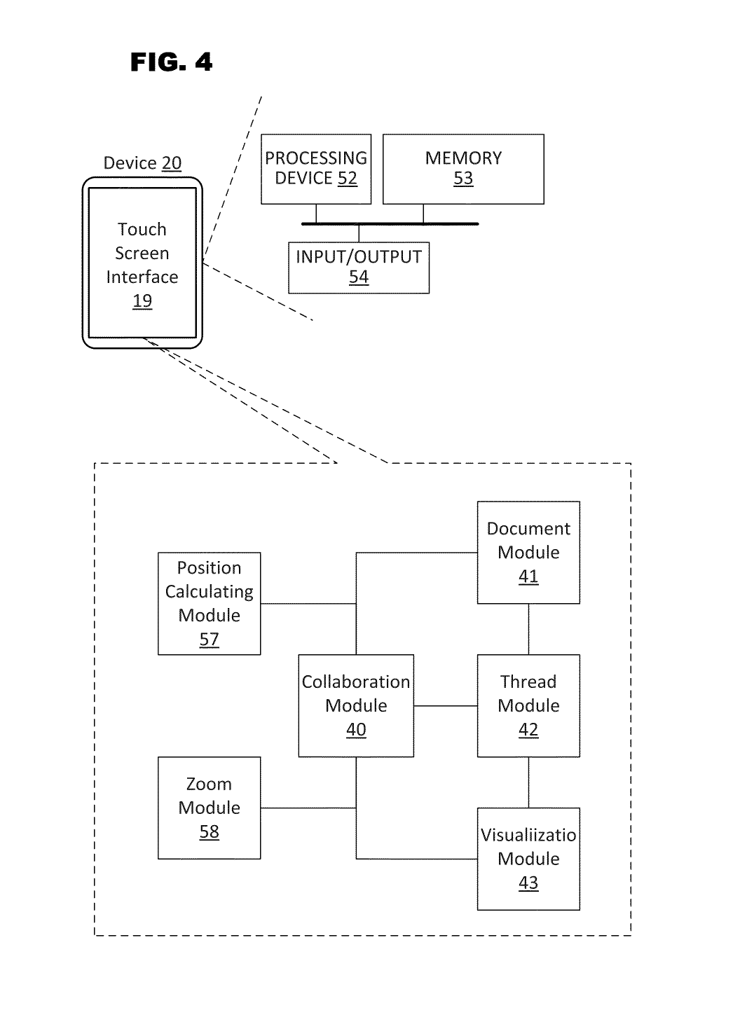

FIG. 4 illustrates a representative architecture of a portable electronic device according to an example embodiment of the present disclosure.

A portable electronic device 20 may include a touch screen interface 19, processing device 52, memory 53, communications interface 54. The touch screen interface 19 may include a display, which may be a touch screen, capable of displaying data to a user of the portable electronic device 20.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Portable electronic device 20 may also include a collaboration module 40 that generally implements the functionality of a collaboration application. Collaboration module 40 may be coupled to other modules including document module 41, thread module 42, visualization module 43, position calculating module 57, and zoom module 58. Each of the modules may be part of the collaboration application, or alternatively, may be part of another application and accessed by the collaboration application. For example, the position calculating module 57 is coupled to zoom module 58, both of which may be shared by a variety of applications using the touch screen interface 19.

Document module 41 and thread module 42 are operable to display the document selected by a user and any corresponding communication threads. Document module also enables a user to select alternate documents. Thread module displays any communication threads associated with a displayed document, and enables a user to input additional messages to an existing thread and to initiate new communication threads. Visualization module 43 enables the display features of the collaboration application while documents and communication threads would still be stored on collaborative document server 10.

Memory 53 may include a computer readable medium storing application modules, which may include instructions associated with applications and modules of the portable electronic device 20.

The position calculation module 57 may include functionality for identifying a touched first point and second point within a collaboration application displaying a business document and communication thread within a divided display of the touch screen interface 19. The position calculation module 57 may also include functionality for calculating a change in a distance between the first point and the second point in response to a dragging of at least one of the touched points. In addition, the zoom module 58 may include functionality for identifying whether detected movements on the touch screen correspond to a zooming in or out, or correspond to other instructions.

The device 20 may contain a processing device 52, memory 53, and a communications device 54, all of which may be interconnected via a system bus. In various embodiments, the device 20 may have an architecture with modular hardware and/or software systems that include additional and/or different systems communicating through one or more networks via communications device 54.

Communications device 54 may enable connectivity between the processing devices 52 in the portable electronic device 20 and other systems by encoding data to be sent from the processing device 52 to another system over a network and decoding data received from another system over the network for the processing device 52.

In an embodiment, memory 53 may contain different components for retrieving, presenting, changing, and saving data and may include computer readable media. Memory 53 may include a variety of memory devices, for example, Dynamic Random Access Memory (DRAM), Static RAM (SRAM), flash memory, cache memory, and other memory devices. Additionally, for example, memory 53 and processing device(s) 52 may be distributed across several different computers that collectively comprise a system. Memory 53 may be capable of storing user inputs and preferences as well as customized sequences. In some instances, a cache in memory 53 may store new communications within a communication thread prior to being posted on server 10.

Processing device 52 may perform computation and control functions of a system and comprises a suitable central processing unit (CPU). Processing device 52 may include a single integrated circuit, such as a microprocessing device, or may include any suitable number of integrated circuit devices and/or circuit boards working in cooperation to accomplish the functions of a processing device. Processing device 52 may execute computer programs, such as object-oriented computer programs, within memory 53.

The foregoing description has been presented for purposes of illustration and description. It is not exhaustive and does not limit embodiments of the disclosure to the precise forms disclosed. For example, although the processing device 52 is shown as separate from the modules 41-43 and the touch screen interface 19, in some instances the processing device 52 and the touch screen interface 19 and/or one or more of the modules 41-43 may be functionally integrated to perform their respective functions.

It will be apparent to those skilled in the art that various modifications and variations can be made in the collaborative document portal of the present disclosure without departing from the spirit or scope of the disclosure. Thus, it is intended that the present disclosure cover the modifications and variations of this disclosure provided they come within the scope of the appended claims and their equivalents.

We claim:

1. A method comprising:
receiving a document from a first user;
receiving a message associated with the document from a second user;
generating a communication thread for the document, the communication thread including the message from the second user;
associating the communication thread with the document;
providing the communication thread to the first user;
receiving a message from the first user;
inserting the message from the first user in the communication thread; and
providing the communication thread and a portion of the document to the second user for display.

2. The method of claim 1, further comprising:
receiving a another version of the document; and
generating a new communication thread for the new version of the document.

3. The method of claim 1, further comprising sending a notification to the second user to indicate that the first user has uploaded the document.

4. The method of claim 1, further comprising sending a notification to the first user to indicate that the second user has initiated a communication thread.

5. The method of claim 1, wherein the communication thread and the portion of the document are simultaneously displayed.

6. The method of claim 3, wherein the notification includes a link to the document.

7. The method of claim 3, wherein the notification includes a link to the communication thread and the document.

8. A server comprising:
one or more process; and
memory storing one or more programs for execution by the one or more process, the one or more programs including instructions for:
receiving a document from a first user;
receiving a message associated with the document from a second user;
generating a communication thread for the document, the communication thread including the message from the second user;
associating the communication thread with the document;
providing the communication thread to the first user;
receiving a second message from the first user;
inserting the second message from the first user in the communication thread; and
providing the communication thread and a portion of the document to the second user for display.

9. The server of claim 7, further comprising sending a notification to a portable electronic device of the second user when the first user has modified the electronic file stored in the collaboration server.

10. The server of claim 7, wherein the collaboration server triggers an alert to be sent to a portable electronic device of the second user when the first user has updated the communication thread stored in the collaboration server.

11. The server of claim 7, wherein the collaboration server is operable to simultaneously display the electronic file and communication thread to the first and second users.

12. A non-transitory computer readable storage medium storing one or more programs configured to be executed by a processor, the one or more programs comprising instructions for:
receiving a document from a first user;
receiving a message associated with the document from a second user;
generating a communication thread for the document, the communication thread including the message from the second user;
associating the communication thread with the document;
providing the communication thread to the first user;
receiving a second message from the first user;
inserting the second message from the first user in the communication thread; and
providing the communication thread and a portion of the document to the second user for display.

13. The computer readable medium of claim 12, further comprising:
receiving a modification for the document;
updating the document in accordance to the modification to generate a new version of the document; and
generating a new communication thread for the new version of the document.

14. The computer readable medium of claim 12, further comprising sending a notification to the second user to indicate that the first user has uploaded the document.

15. The computer readable medium of claim 12, further comprising sending a notification to the first user to indicate that the second user has initiated a communication thread.

16. The computer readable medium of claim 12, wherein the communication thread and the portion of the document are simultaneously displayed.
